(19) United States
(12) Patent Application Publication
(10) Pub. No.: US 2025/0293455 A1
(43) Pub. Date: Sep. 18, 2025

(54) CONNECTOR AND CONNECTOR PAIR

(71) Applicant: Molex, LLC, Lisle, IL (US)

(72) Inventors: Teruki Nagase, Yamato (JP); Satoshi Okumura, Yamato (JP); Shuichi Sato, Yamato (JP)

(21) Appl. No.: 19/047,659

(22) Filed: Feb. 7, 2025

(30) Foreign Application Priority Data
Mar. 15, 2024 (JP) 2024-041416

(51) Int. Cl. H01R 13/506; H01R 12/75; H01R 13/631; H01R 13/639

(52) U.S. Cl. CPC H01R 13/506; H01R 13/631; H01R 13/639; H01R 12/75

(57) ABSTRACT

The metal fitting includes a main body part secured to the housing, a first L-shaped part at least a portion of which is exposed outside the housing near the opening frontage of the storage recessed part, and a second L-shaped part exposed in the opening frontage of the storage recessed part, wherein the first L-shaped part and the second L-shaped part include surfaces facing each other via the wall of the housing, the main body part is flat, the edge part of the main body part on the second L-shaped part includes a convex part that engages with the housing, and the edge part of the main body part of the first L-shaped part includes a guide part that can slide against the housing.

### TECHNICAL FIELD

The present disclosure relates to a connector and a connector pair.

### BACKGROUND

Conventionally, connectors known as wire-to-substrate connectors have been used to connect electric wires such as cables to substrates such as printed circuit substrates. In such connectors, one connector is mounted on a substrate and mates with another connector connected to the end of a cable (see, for example, Patent Document 1).

FIG. 33 is an exploded view depicting a conventional connector.

In the figure, the connector has a housing 811, a plurality of contact pins 861, and a pair of reinforcing metal fittings 851. The housing 811 is a member mounted on a circuit substrate (not depicted), and is formed with a long and narrow mating recessed part 813 for mating with a counterpart connector (not depicted). Furthermore, a plurality of groove parts 814 are formed in the bottom wall part 812 of the housing 811, and a contact pin 861 is disposed in each groove part 814.

The contact pin 861 is a rod-shaped conductive metal member extending in the up-down direction, and a lead part 862 extending in the front-back direction is formed at the lower end thereof. Furthermore, when the lead parts 862 are stored in the groove parts 814, the contact pins 861 pass through mounting holes (not depicted) formed in the bottom wall part 812 and protrude into the mating recessed part 813. Furthermore, a support piece 865 protruding upward from the lead part 862 is inserted into and held in a recessed part (not depicted) formed in the bottom wall part 812.

Furthermore, a top solder surface 863 and a side solder surface 864 are formed at the end part of the lead part 862, and are exposed on the outer surface of the housing 811. The top solder surface 863 is a portion that is soldered to the solder pad on the surface of the substrate when the connector is a straight type, in other words, when the bottom wall part 812 of the housing 811 faces the surface of the substrate (not depicted) and the mating recessed part 813 is orientated so as to open in a direction perpendicular to the substrate surface. In addition, the side solder surface 864 is a portion that is soldered to the solder pad on the surface of the substrate when the connector is a right angle type, or in other words, when the bottom wall part 812 of the housing 811 is perpendicular to the surface of the substrate (not depicted) and the mating recessed part 813 is open and faces in a direction parallel to the surface of the substrate.

Furthermore, engaging holes 815 are formed in the side wall parts on both sides of the housing 811, and reinforcing metal fittings 851 are inserted and held in the engaging holes 815. The reinforcing metal fitting 851 is a plate-shaped metal member and has an upper side part 852 and a lower side part 853. Furthermore, the front end of the upper side part 852 is a portion that is exposed to the front surface of the housing 811 and is soldered to a solder pad on the surface of the substrate when the connector is a right angle type. Furthermore, the lower end of the lower side part 853 is the portion that is exposed on the lower surface of the bottom wall part 812 of the housing 811, and is soldered to a solder pad on the surface of the substrate when the connector is a straight angle type.

Furthermore, when the connector is mated to a counterpart connector (not depicted), at least a portion of the counterpart connector is inserted into the mating recessed part 813. As a result, the contact pins 861 come into contact with the respective counterpart terminals of the counterpart connector and are electrically connected.
Prior Art Documents: Patent Document 1: Japanese Unexamined Patent Application 2000-268905

### SUMMARY

However, in the conventional connector described above, the reinforcing metal fitting 851 is simply a flat plate-shaped member that is simply inserted and held in the engaging hole 815 of the housing 811. Therefore, when a strong external force is applied, the housing 811 or the reinforcing metal fitting 851 may deform, or the reinforcing metal fitting 851 may detach from the housing 811. For example, if the counterpart connector is an electric wire connector connected to a tip end of an electric wire and a worker or the like grasps the electric wire and applies excessive force that gouges the counterpart connector, the connector housing 811 or reinforcing metal fitting 851 may be deformed or damaged, the reinforcing metal fitting 851 may detach from the housing 811, and even the contact pin 861 may be deformed or damaged.

In order to prevent such a situation from occurring, conceivably, the housing 811 can be made thicker so as to be less prone to deformation, or the reinforcing metal fittings 851 can be made thicker and larger so as to be less prone to deformation. However, in recent years, connectors have become smaller in size in line with the miniaturization of electronic components and electronic devices, and the like, and as a result, each part of the housing 811 and the reinforcing metal fitting 851 has to be extremely intricate, so deformation of each part of the housing 811 and the reinforcing metal fitting 851 that occurs when subjected to a strong external force, or disengaging of the housing 811 and the reinforcing metal fitting 851 cannot easily be prevented.

An object of the present invention is to provide a connector or connector pair which solves the problems of the conventional connectors, and by optimizing the shape and structure of the housing and metal fittings, can prevent disengagement between the housing and the metal fittings even when the housing and the metal fittings are made compact, can reliably prevent deformation or damage to the housing and the metal fittings, can reliably secure the metal fittings to the housing, can reduce the height and size, has a simple configuration, has a small number of parts, is robust, is easy to manufacture, is low cost, and is highly reliable.

Therefore the connector includes a housing including a storage recessed part for storing a counterpart connector, a terminal attached to the housing, and a metal fitting attached to the housing for securing the housing to a substrate; wherein the metal fitting includes a main body part secured to the housing, a first L-shaped part at least a portion of which is exposed to the outside of the housing near the opening frontage of the storage recessed part, and a second L-shaped part exposed in the opening frontage of the storage recessed part; the first L-shaped part and the second L-shaped part include surfaces that face each other across a wall of the housing; and the main body part is flat, the edge part of the main body part on the second L-shaped part side includes a convex part that engages with the housing, and the edge part of the main body part on the first L-shaped part side includes a guide part that can slide against the housing.

In another connector, in addition, the main body part further includes a first edge part visible through a through hole in the bottom part of the storage recessed part.

In yet another connector, in addition, the first edge part protrudes from the bottom part.

In still another connector, in addition, the housing also has a slit on the first L-shaped part side of the metal fitting at the opening frontage, and an arm part connecting the first L-shaped part to the main body part is positioned in the slit.

In yet another connector, in addition, an edge part of the main body part facing the counterpart connector has a metal fracture surface on the first L-shaped part side, and the fracture surface is formed on the arm part.

In yet another connector, in addition, one metal fitting is attached to each side of the housing, the housing having a convex locking member that engages with the counterpart connector, and the locking member is positioned between the second L-shaped parts of the metal fittings on both sides.

The connector pair includes a connector according to the present disclosure and a counterpart connector that mates with the connector.

The present disclosure can provide a mechanism that prevents disengagement between a housing and a metal fitting, reliably prevents deformation or damage to the housing and the metal fitting, reliably secures the metal fitting to the housing, reduces the height and size, has a simple configuration, has a small number of parts, is robust, is easy to manufacture, has low cost, and has enhanced reliability, even if the housing and the metal fittings are compact.

### BRIEF DESCRIPTION OF THE DRAWINGS

FIG. 1 is a first perspective view depicting a state before a connector and a counterpart connector according to a first embodiment are mated together;

FIG. 2 is a second perspective view depicting a state before a connector and a counterpart connector according to a first embodiment are mated together;

FIG. 3 is a third perspective view depicting a state before a connector and a counterpart connector according to a first embodiment are mated together;

FIG. 4 is a fourth perspective view depicting a state before a connector and a counterpart connector according to a first embodiment are mated together;

FIGS. 5A and 5B depict first and second perspective views depicting a state after the connector and the counterpart connector of the first embodiment are mated, where FIG. 5A is a first perspective view and FIG. 5B is a second perspective view;

FIGS. 6A and 6B depict third and fourth perspective views depicting a state after the connector and the counterpart connector of the first embodiment are mated, where FIG. 6A is a third perspective view and FIG. 6B is a fourth perspective view;

FIGS. 7A and 7B depict first and second perspective views depicting a state in which the connector of the first embodiment is mounted on a surface of the substrate as a right angle type connector, where FIG. 7A is a first perspective view and FIG. 7B is a second perspective view;

FIG. 8 is a first exploded perspective view of the connector of the first embodiment;

FIG. 9 is a second exploded perspective view of the connector of the first embodiment;

FIG. 10 is a third exploded perspective view of the connector of the first embodiment;

FIG. 11 is a fourth exploded perspective view of the connector of the first embodiment;

FIGS. 12A and 12B depict fifth and sixth exploded perspective views of the connector according to the first embodiment, where FIG. 12A is the fifth exploded perspective view and FIG. 12B is the sixth exploded perspective view;

FIGS. 13A and 13 B depict diagrams for describing a step of attaching a metal fitting to the connector according to the first embodiment, where FIG. 13A depicts the state before the metal fitting is attached, and FIG. 13B depicts the state after the metal fitting has been attached;

FIGS. 14A-14C are a three view diagram of the connector of the first embodiment, where FIG. 14A is a front view, FIG. 14B is a cross-sectional view along line A-A in FIG. 14A, and FIG. 14C is a perspective view containing a cross-sectional view along line A-A in FIG. 14A.

FIGS. 15A and 15B depict first and second exploded perspective views of the counterpart connector according to the first embodiment, where FIG. 15A is a first perspective view and FIG. 15B is a second perspective view;

FIGS. 16A and 16B depict third and fourth exploded perspective views of the counterpart connector according to the first embodiment, where FIG. 16A is a third perspective view and FIG. 16B is a fourth perspective view;

FIGS. 17A-17C are a three view diagram depicting the state after the connector and the counterpart connector of the first embodiment are mated, where FIG. 17A is a upper surface view, FIG. 17B is a cross-sectional view along line B-B of FIG. 17A, and FIG. 17C is a perspective view including the cross-sectional view along line B-B of FIG. 17A;

FIGS. 18A and 18B are a perspective view depicting a state in which the connector of the second embodiment is mounted on a surface of the substrate as a straight type connector, where FIG. 18A is a first perspective view, and FIG. 18B is a second perspective view;

FIG. 19 is a first perspective view depicting a state before a connector and a counterpart connector according to the third embodiment are mated together;

FIG. 20 is a second perspective view depicting a state before a connector and a counterpart connector according to the third embodiment are mated together;

FIG. 21 is a third perspective view depicting a state before a connector and a counterpart connector according to a third embodiment are mated together;

FIG. 22 is a fourth perspective view depicting a state before a connector and a counterpart connector according to a third embodiment are mated together;

FIGS. 23A and 23B depict first and second perspective views depicting a state after the connector and the counterpart connector of the third embodiment are mated, where FIG. 23A is a first perspective view, and FIG. 23B is a second perspective view;

FIGS. 24A and 24B depict third and fourth perspective views depicting a state after the connector and the counterpart connector of the third embodiment are mated, where FIG. 24A is a third perspective view and FIG. 24B is a fourth perspective view;

FIGS. 25A and 25B are a two view diagram depicting a state after the connector and the counterpart connector in the third embodiment are mated, in which FIG. 25A is a plan view, and FIG. 25B is a cross-sectional view along line C-C in FIG. 25A;

FIG. 26 is a first perspective view depicting a state before a connector and a counterpart connector according to a fourth embodiment are mated together;

FIG. 27 is a second perspective view depicting a state before a connector and a counterpart connector according to a fourth embodiment are mated together;

FIG. 28 is a third perspective view depicting a state before a connector and a counterpart connector according to a fourth embodiment are mated together;

FIG. 29 is a fourth perspective view depicting a state before a connector and a counterpart connector according to a fourth embodiment are mated together;

FIGS. 30A and 30B depict first and second perspective views depicting a state after the connector and the counterpart connector of the fourth embodiment are mated, where FIG. 30A is a first perspective view and FIG. 30B is a second perspective view;

FIGS. 31A and B depict third and fourth perspective views depicting a state after the connector and the counterpart connector of the fourth embodiment are mated, where FIG. 31A is a third perspective view and FIG. 31B is a fourth perspective view;

FIGS. 32A and B are a two view diagram depicting a state after the connector and the counterpart connector in the fourth embodiment are mated, in which FIG. 32A is a plan view, and FIG. 32B is a cross-sectional view along line D-D in FIG. 32A; and

FIG. 33 is an exploded view depicting a conventional connector.

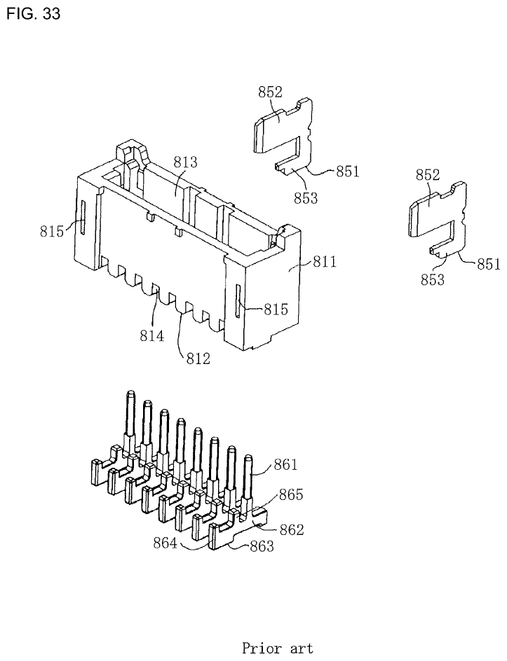

### DETAILED DESCRIPTION

Embodiments will hereinafter be described in detail with reference to the drawings.

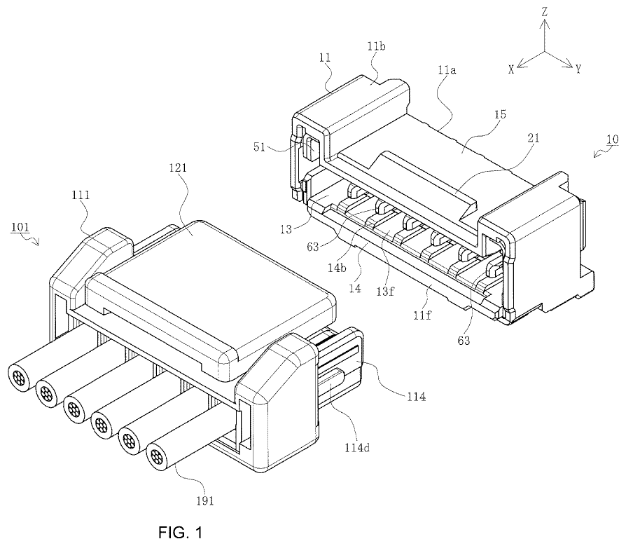

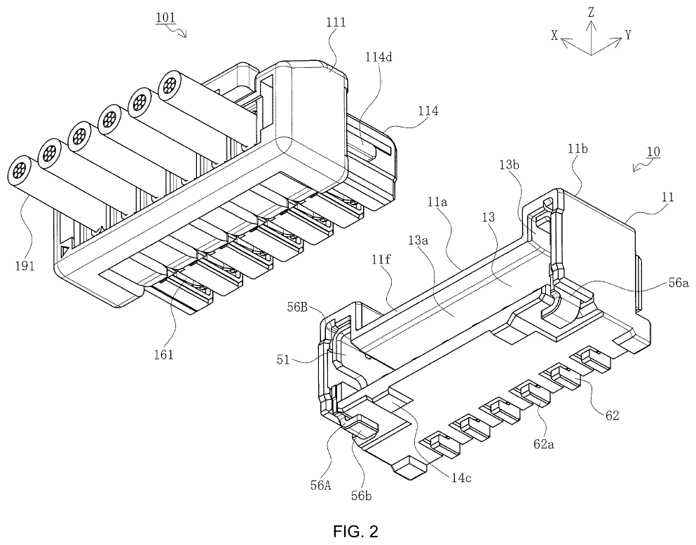

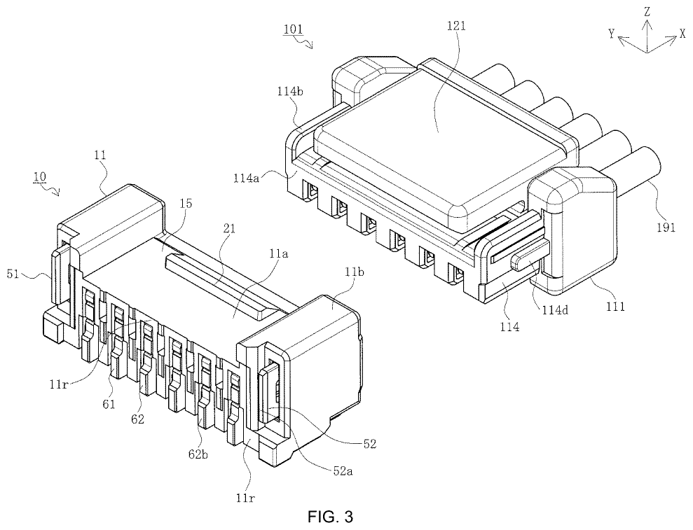

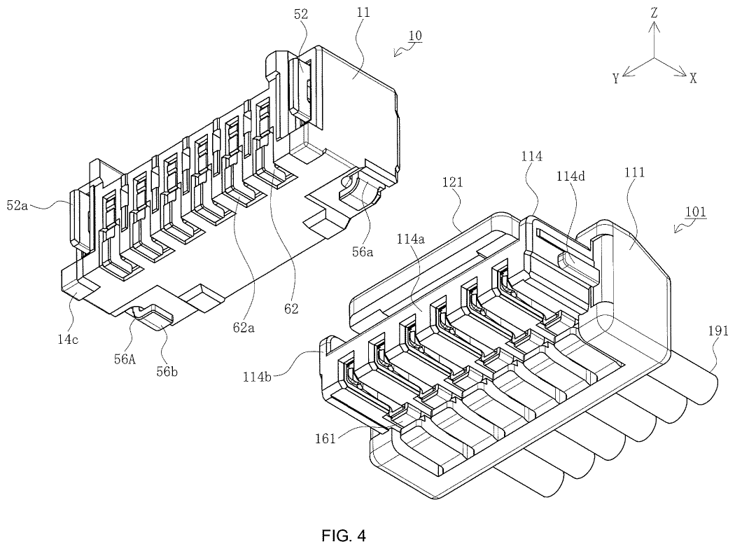

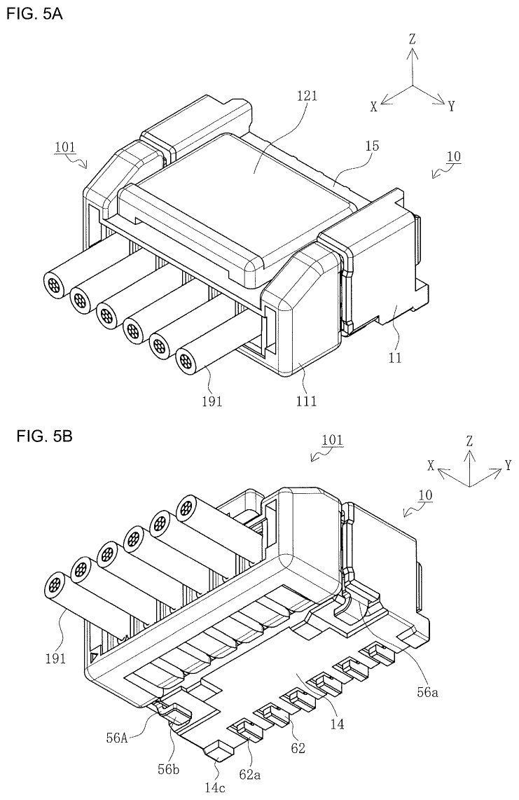

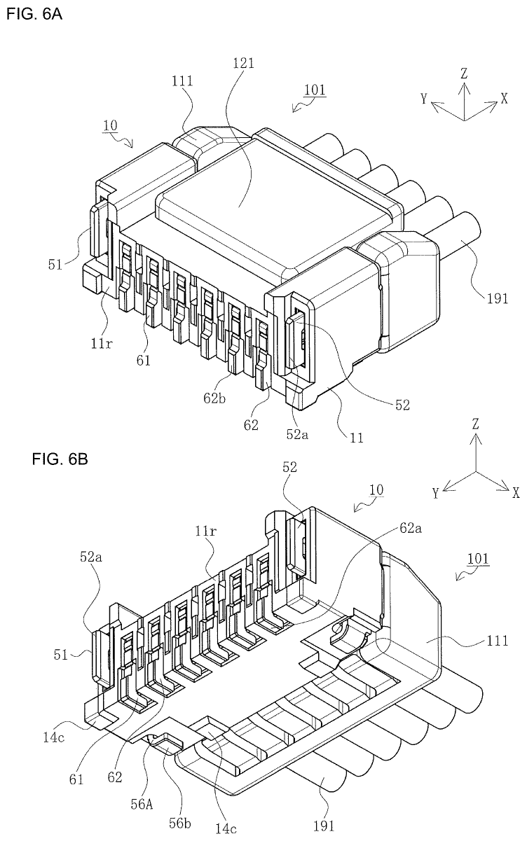

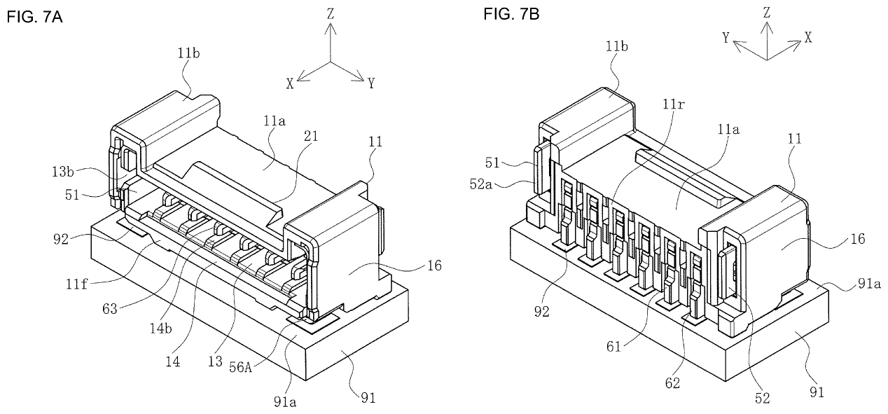

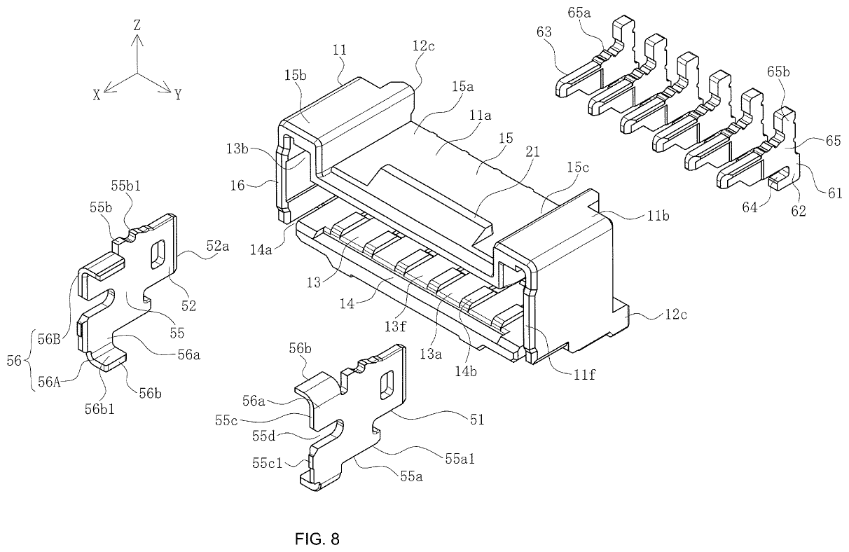

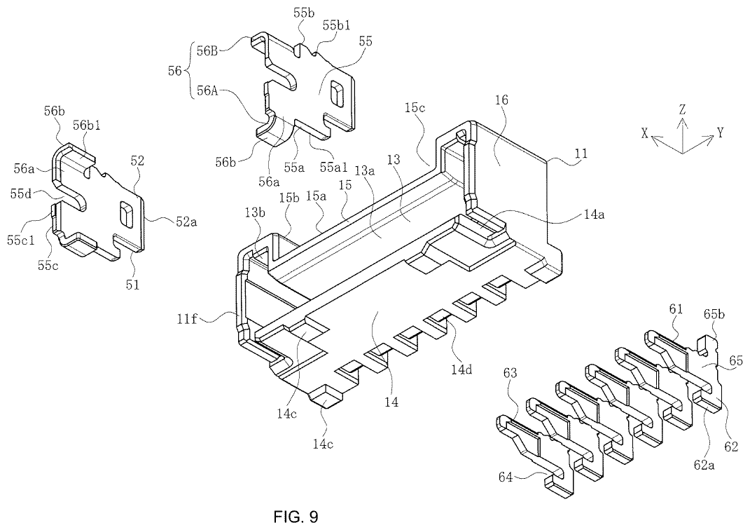

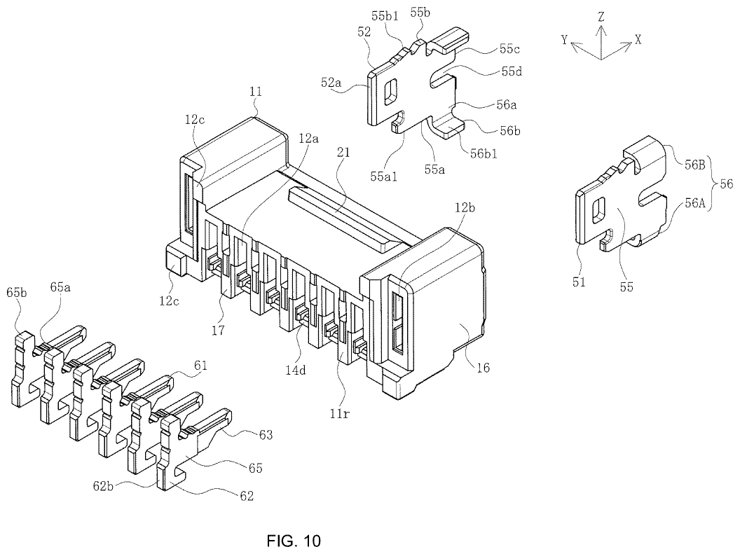

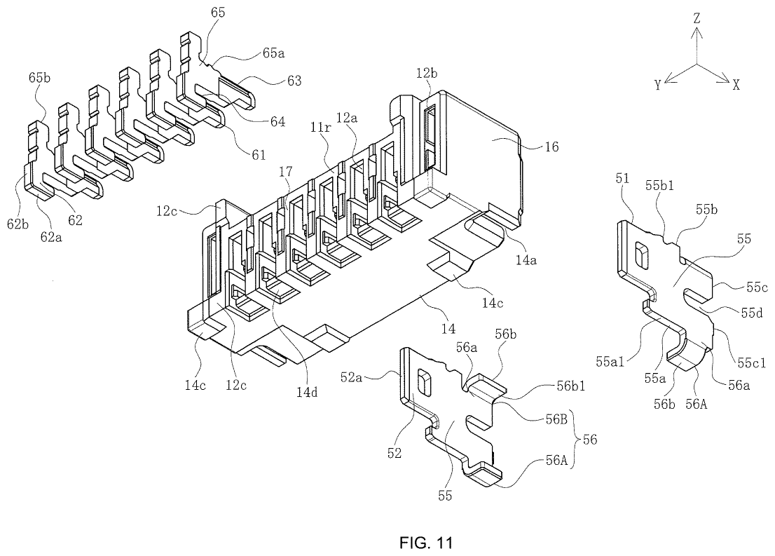

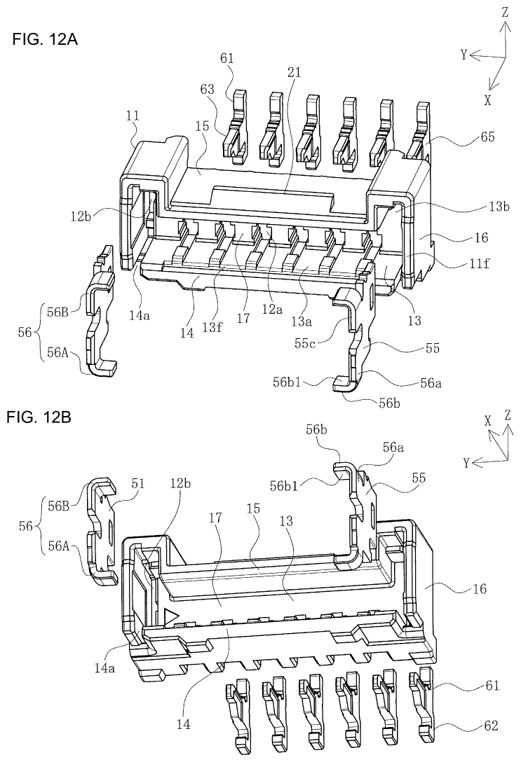

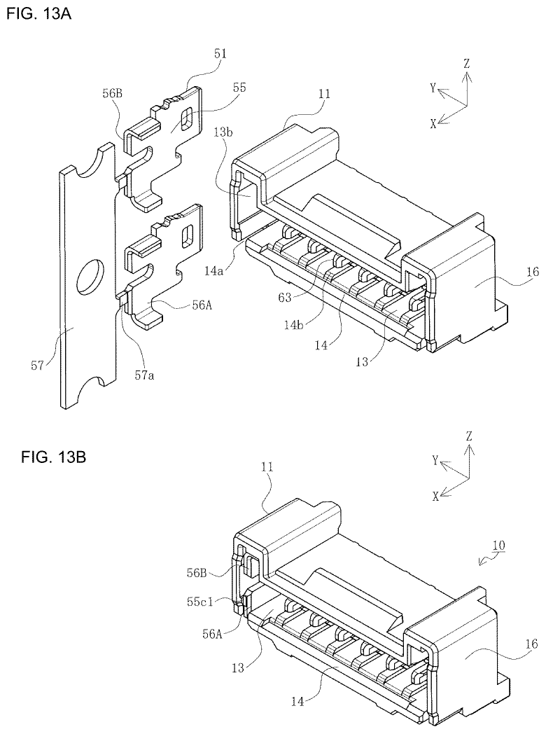

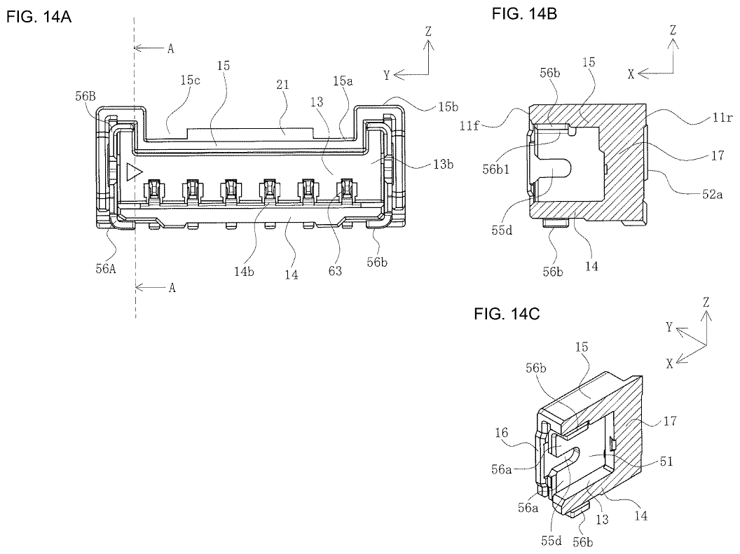

FIG. 1 is a first perspective view depicting a state before a connector and a counterpart connector according to a first embodiment are mated together; FIG. 2 is a second perspective view depicting a state before a connector and a counterpart connector according to a first embodiment are mated together; FIG. 3 is a third perspective view depicting a state before a connector and a counterpart connector according to a first embodiment are mated together; FIG. 4 is a fourth perspective view depicting a state before a connector and a counterpart connector according to a first embodiment are mated together; FIGS. 5A and 5B depict a first and second perspective view depicting a state after a connector and a counterpart connector according to a first embodiment are mated together; FIGS. 6A and 6B depict a third and fourth perspective view depicting a state after a connector and a counterpart connector according to a first embodiment are mated together; FIGS. 7A and 7B depict a first and second perspective view depicting a state in which the connector according to the first embodiment is mounted on the surface of the substrate as a right angle type connector; FIG. 8 is a first exploded perspective view of the connector of the first embodiment; FIG. 9 is a second exploded perspective view of the connector of the first embodiment; FIG. 10 is a third exploded perspective view of the connector of the first embodiment; FIG. 11 is a fourth exploded perspective view of the connector of the first embodiment; FIGS. 12A and 12B are a fifth and sixth exploded perspective view of the connector of the first embodiment; FIGS. 13A and 13B are a diagram for describing a step of attaching a metal fitting to a connector according to the first embodiment; and FIGS. 14A-14C are a three view diagram of the connector according to a first embodiment. It should be noted that in FIGS. 5A and 5B, FIG. 5A is the first perspective view and FIG. 5B is the second perspective view; in FIGS. 6A and 6B, FIG. 6A is the third perspective view and FIG. 6B is the fourth perspective view; in FIGS. 7A and 7B, FIG. 7A is the first oblique perspective view and FIG. 7B is the second perspective view; in FIGS. 12A and 12B, FIG. 12A is the fifth exploded perspective view and FIG. 12B is the sixth exploded perspective view; in FIGS. 13A and 13B, FIG. 13A is a diagram depicting the state before the metal fittings are attached, and FIG. 13B is a diagram showing the state after the metal fittings are attached; and in FIGS. 14A-14C, FIG. 14A is a front view, FIG. 14B is a cross-sectional view taken along line A-A in FIG. 14A, and FIG. 14C is a perspective view including the cross-sectional view taken along line A-A in FIG. 14A.

In the figures, 10 is a connector in the present embodiment, which is a substrate connector that is one of a pair of wire-to-substrate connectors. The connector 10 is a surface-mount plug connector that is mounted on a surface 91a of a substrate 91 serving as a mounting member, and is mated with a counterpart connector 101 that is a receptacle connector. It should be noted that the counterpart connector 101 is a wire connector that serves as the other of the wire-to-substrate connectors of a connector pair, and is a connector that is connected to an end of a cable that includes a plurality of electric wires 191.

Here, the connector 10 is a so-called right angle type substrate connector, and as depicted in FIGS. 7A and 7B, when the connector 10 and the counterpart connector 101 are mated, the storage recessed part 13 into which a mating convex part 114 of the counterpart housing 111 of the counterpart connector 101 is stored and mated is mounted on the surface of the substrate 91 with the opening facing in a direction parallel to the surface of the substrate 91. However, the connector 10 is not limited to a right-angle type, and may be a so-called straight type connector in which the storage recessed part 13 is mounted on the surface 91a of the substrate 91 with the opening facing upward (positive direction of the Z axis), or the storage recessed part 13 may be open facing in an oblique direction intersecting with the surface 91a of the substrate 91, and the storage recessed part 13 may be open facing in any direction. In the present embodiment, for convenience of description, a case is described in which the connector 10 is a so-called right angle type connector.

Furthermore, the substrate 91 is, for example, a printed circuit board used in electronic devices and the like, but may be a flexible flat cable (FFC), a flexible circuit substrate (FPC), or the like, or a silicon substrate or silicon carbide substrate with electronic elements directly provided on the surface, or any other type of substrate. Furthermore, the electronic device is, for example, a personal computer, a smartphone, a digital television, a vehicle navigation device, a game device, or the like, but may be any kind of electronic device.

Furthermore, the wire-to substrate connector, which is the connector pair in the present embodiment, electrically connects the substrate 91 and the electric wire 191. It should be noted that the present embodiment describes that the electrical wire 191 is a signal line, and the end part of the electrical wire 91 on the side opposite the counterpart connector 101 is connected to an electronic device or the like (not depicted), and the connector 10 and counterpart connector 101 are connectors for connecting a signal line to the substrate 91, but the electrical wire 191 can also be a power line or a ground line, and the connector 10 and the counterpart connector 101 can also be used as a connector for connecting a power line and a ground line.

Furthermore, in the present embodiment, expressions indicating direction such as up, down, left, right, front, rear, longitudinal, width, and the like used to describe a configuration and operation of each part of the connector pair connector 10 and the counterpart connector 101 are relative rather than absolute and are appropriate when each part of the connector 10 and the counterpart connector 101 are in positions depicted in the drawings. However, these directions should be interpreted as changing in accordance with a change in position when the position thereof is changed.

The connector 10 includes a housing 11 formed integrally from an insulating material such as synthetic resin or the like and having a generally flat overall shape, a terminal 61 made of a conductive metal attached to the housing 11, and a metal fitting 51 which is a metal housing mounting auxiliary fitting attached to the housing 11 for securing the housing 11 to the substrate 91. The number and arrangement of the terminals 61 correspond to the number of electric wires 191 to be connected to the counterpart connector 101 and the number and arrangement of the counterpart terminals 161 connected to the ends of the electric wires 191. Note that in the example depicted in the figure, the number of terminals 61 is six, but the number of terminals 61 can be changed arbitrarily and may be, for example, five or fewer, or seven or more. Furthermore, in the example depicted in the drawings, the plurality of terminals 61 are arranged in a single row in the width direction (Y-axis direction) of the connector 10, but the present invention is not necessarily limited to this, and for example, the arrangement pattern may be staggered or may be two or more rows.

As depicted in FIGS. 8 to 12B, terminal 61 in the present embodiment is a member formed integrally by stamping a metal plate, and has a generally T-shaped side profile as a whole. Furthermore, the terminal 61 includes a main body part 65 and a contact part 63 that extends in the direction that the connector 10 is mated with the counterpart connector 101, or in other words, in the mating direction (X-axis direction). Specifically, the contact part 63 extends forward (in the positive direction of the X-axis) from the front end of the main body part 65. Furthermore, the terminal 61 also includes a tail part 62 as a substrate connecting part having a generally L-shaped side surface connected to the lower surface of the rear end (end in the negative direction of the X-axis) of the main body part 65. The lower surface 62a of the tail part 62 functions as a substrate connecting surface that connects to a connecting pad 92 formed on the surface 91a of the substrate 91 when the connector 10 is a right angle type connector and the terminal 61 is attached to the housing 11. On the other hand, the rear surface 62b of the tail part 62 functions as a substrate connecting surface that is connected to a connecting pad 92 formed on the surface 91a of the substrate 91 when the connector 10 is a straight type connector and the terminal 61 is attached to the housing 11. Furthermore, an engaging convex part 65a that engages with the housing 11 is formed on the upper edge of the main body 65, and an upper protruding part 65b that extends upward is formed on the rear end of the main body part 65. Furthermore, an engaging recessed part 64 is formed between the lower edge of the main body part 65 and the lower part extending forward of the tail part 62, into which the rear edge part 14d of the lower wall part 14, which is one of the walls of the housing 11, enters and engages.

Furthermore, as depicted in FIGS. 8 to 12B, the metal fitting 51 is a member integrally formed by bending and punching a metal plate, and includes a flat main body part 55, a first L-shaped part 56A which is the portion connected to the lower end side of the main body part 55 near the front edge part 55c of the main body part 55 and is bent at approximately 90 degrees, and a second L-shaped part 56B which is connected to the upper end side of the main body part 55 and is bent at approximately 90 degrees. Therefore, when viewed from the mating direction (X-axis direction), the metal fitting 51 has a roughly C-shape or U-shape, and both end portions of the main body part 55 in the vertical direction (Z-axis direction) protrude laterally. It should be noted that when the first L-shaped part 56A and the second L-shaped part 56B are described collectively, they will be described as the L-shaped part 56. When the metal fitting 51 is attached to the housing 11, the first L-shaped part 56A is the portion that is at least partially exposed to the outside of the housing 11 near the opening frontage 13f of the storage recessed part 13 of the housing 11, and the second L-shaped part 56B is the portion that is exposed in the opening frontage 13f of the storage recessed part 13 of the housing 11.

Each L-shaped part 56 forms the same plane as the main body part 55 and includes an arm part 56a extending in the vertical direction (Z-axis direction) from the main body part 55, and a tip end part 56b connected to the tip end of the arm part 56a via a curved part bent at approximately 90 degrees and extending to the inside in the width direction (Y-axis direction) of the connector 10. It should be noted that the inner surface of the tip end part 56b of the first L-shaped part 56A and the inner surface of the tip end part 56b of the second L-shaped part 56B face each other to form an opposing surface 56b1. The tip end part 56b of the first L-shaped part 56A functions as a substrate connecting part that is connected to a connecting pad 92 formed on the surface 91a of the substrate 91 when the connector 10 is a right angle type connector and the metal fitting 51 is attached to the housing 11.

In addition, the second edge part 55b, which is the edge part on the second L-shaped part 56B side of the main body part 55, has an engaging convex part 55b1 that engages with the housing 11, and the first edge part 55a, which is the edge part on the first L-shaped part 56A side of the main body part 55, has a guide part 55al that can slide against the housing 11. Furthermore, when the metal fitting 51 is attached to the housing 11, the first edge part 55a is a slit that penetrates the lower wall part 14 of the housing 11 in the thickness direction and can be seen from outside the housing 11 through the lower wall opening 14a formed in the opening frontage 13f. It should be noted that the first edge part 55a can be made to protrude downward from the lower wall part 14 through the lower wall opening 14a and function as a substrate connecting part to be connected to a connecting pad 92 formed on the surface 91a of the substrate 91. In addition, when the metal fitting 51 is attached to the housing 11, at least a portion of the arm part 56a of the first L-shaped part 56A is preferably positioned within the lower wall opening 14a.

Furthermore, the main body part 55 includes a rear end part 52 that extends toward the rear of the connector 10 (negative direction of the X-axis). The rear end part 52 is a portion that is exposed to the rear of the housing 11 when the metal fitting 51 is attached to the housing 11. Furthermore, the rear edge part 52a, which is the first edge part of the main body part 55 and the edge part of the rear end part 52, functions as a substrate connecting part that connects to a connecting pad 92 formed on the surface 91a of the substrate 91 when the metal fitting 51 is attached to the housing 11 when the connector 10 is a straight type connector, as described below. Furthermore, a front edge part 55c, which is an edge part of the main body part 55 on the side facing the counterpart connector 101, includes a metal fracture surface 55cl at a location corresponding to the arm part 56a of the first L-shaped part 56A. The fracture surface 55cl is a cut surface that is generated when the metal fitting 51 is separated from the connecting arm 57a of the metal fitting carrier 57, as depicted in FIGS. 13A and B. The metal fitting 51 is a member that is a metal plate bent in the plate thickness direction and is made by processing, such as by punching and bending a metal plate. As depicted in FIG. 13A, a plurality of metal fittings are provided connected to a flat plate-shaped metal fitting carrier 57 as a carrier. Furthermore, each of the metal fittings 51 has a front edge part 55c connected to the flat plate-like metal fitting carrier 57 via an elongated connecting arm 57a, and when the front edge part 55c is separated from the connecting arm 57a at a cut part, a member is formed as depicted in FIGS. 8 to 12B.

Furthermore, the main body part 55 is formed with an elongated recessed part 55d that opens at the front edge part 55c and extends rearward. The recessed part 55d is a portion into which the side surface convex part 114d provided on a side surface of the mating convex part 114 of the counterpart connector 101 enters and engages when the connector 10 and the counterpart connector 101 are mated.

The housing 11 is a hollow box-shaped member having a generally flat overall shape, and includes a flat lower wall part 14 extending in the width direction (Y-axis direction) of the connector 10, an upper wall part 15 that is generally parallel to the lower wall part 14, and a pair of side wall parts 16 that extend in the vertical direction and connect the lower wall part 14 and the upper wall part 15. The interior thereof forms a storage recessed part 13 with a periphery defined by the lower wall part 14, the upper wall part 15, and the side wall part 16. The storage recessed part 13 is open on the front surface side (X-axis positive direction side) and is generally closed on the rear side (X-axis negative direction side) by a rear wall part 17 of the housing 11 which serves as the bottom part of the storage recessed part 13. Furthermore, the housing 11 can be divided into a roughly rectangular parallelepiped main body part 11a extending in the width direction of the connector 10, and side parts 11b connected to both sides in the width direction of the main body part 11a and protruding upward.

Furthermore, while the lower wall part 14 is a single flat plate across the entire housing 11, the upper wall part 15 is divided into a main body upper wall part 15a corresponding to the main body part 11a and a side upper wall part 15b corresponding to the side part 11b. The side upper wall part 15b is located above (positive direction of the Z axis) the main body upper wall part 15a, and the upper recessed part 15c is above the main body upper wall part 15a. It should be noted that a convex locking member 21 that engages with a counterpart locking member 121 of the counterpart connector 101 is formed on the outer side of the main body upper wall part 15a, or in other words, on the upper surface of the housing 11. The upper recessed part 15c is a recessed part in which a counterpart locking member 121 is stored when the connector 10 and the counterpart connector 101 are mated together.

Furthermore, the storage recessed part 13 is partitioned into a main body recessed part 13a corresponding to the main body part 11a and a side recessed part 13b corresponding to the side part 11b. The side recessed part 13b is a vertically elongated space that protrudes upward from the main body recessed part 13a. Therefore, the storage recessed part 13 has a generally C- or U-shape when viewed from the mating direction (X-axis direction), with both end portions in the width direction (Y-axis direction) protruding upward. Therefore, the mating convex part 114 of the counterpart connector 101, which is stored in and mated with the storage recessed part 13, also has a mating main body 114a that extends elongated in the width direction (Y-axis direction) and mating side parts 114b that are formed at both end portions of the mating main body 114a in the width direction and protrude upward, and has an approximately C-shape or U-shape when viewed from the mating direction. It should be noted that the portion of the storage recessed part 13 on the front surface 11f side of the housing 11 is referred to as the opening frontage 13f.

Furthermore, the lower wall opening 14a, which is a slit penetrating the lower wall part 14 in the thickness direction, is formed in the lower wall part 14 at a location corresponding to the side recessed part 13b and adjacent to the side wall part 16. As depicted in FIG. 9, the lower wall opening 14a is formed so as to open from an edge of the lower wall part 14 on the front surface 11f side of the housing 11 and extend to the proximity of the middle of the lower wall part 14 in the front-back direction. Additionally, ridge-like parts 14b that protrude upward are formed at locations corresponding to the contact parts 63 of the terminals 61 in the main body recessed part 13a in the lower wall part 14. Furthermore, the outer surface of the lower wall part 14, in other words, the lower surface of the housing 11, is formed with a convex part 14c that protrudes downward at a plurality of locations. The convex part 14c is a portion that can come into contact with the surface 91a of the substrate 91 when the connector 10 is mounted on the substrate 91 and the connector 10 is a right angle type connector.

Furthermore, terminal storage holes 12a into which the respective terminals 61 are inserted and stored are formed at locations on the rear surface 11r of the housing 11 corresponding to the main body part 11a. Each terminal storage hole 12a is formed as a through hole penetrating the rear wall part 17 in the plate thickness direction, and stores and holds the main body part 65 of each terminal 61. In the example depicted in the figure, six terminal storage holes 12a are arranged in a row in the width direction (Y-axis direction) of the connector 10. Furthermore, the location corresponding to the lower end of the terminal storage hole 12a in the rear end of the lower wall part 14 corresponds to the rear edge part 14d which penetrates and engages with the engaging recessed part 64 of the terminal 61. Furthermore, metal fitting storage holes 12b into which the metal fittings 51 are inserted and stored are opened at the locations on the rear surface 11r corresponding to the side parts 11b. Each metal fitting storage hole 12b is formed as a through hole penetrating the rear wall part 17 in the plate thickness direction, and stores and holds the main body part 55 of each metal fitting 51. When the main body part 55 is stored in the metal fitting storage hole 12b, a portion of the rear end part 52 including at least the rear edge part 52a preferably protrudes rearward from the rear wall part 17 (rear surface 11r), as depicted in the figure. Furthermore, the rear edge part 52a of the rear end part 52 is visible from the metal fitting storage hole 12b. Furthermore, convex parts 12c that protrude rearward at a plurality of locations are formed at the outer surface of the rear wall part 17, or in other words, the rear surface 11r of the housing 11. As described below, if the connector 10 is a straight type connector, the convex part 12c is a portion that can come into contact with the surface 91a of the substrate 91 when the connector 10 is mounted on the substrate 91.

Each terminal 61 is attached by being inserted into a corresponding terminal storage hole 12a from the rear surface 11r side of the housing 11. As depicted in FIGS. 7A, 7B, 14A, 14B, and the like, when attachment of the terminals 61 is completed, the contact parts 63 are located directly above the ridge parts 14b in the storage recessed part 13. Furthermore, the engaging convex part 65a bites into and engages with the upper surface of the terminal storage hole 12a, and the rear edge part 14d penetrates and engages with the engaging recessed part 64, so that the terminal 61 is secured to the housing 11.

Moreover, each metal fitting 51 is attached by being inserted into the corresponding metal fitting storage hole 12b from the front surface 11f side of the housing 11. At this time, the guide part 55al of the first edge part 55a of the main body part 55 slides along the lower surface in the metal fitting storage hole 12b. Furthermore, as depicted in FIGS. 7A, 7B, 13B, 14A, 14B, and the like, when installation of the metal fitting 51 is completed, the engaging convex part 55b1 of the second edge part 55b of the main body part 55 bites into and engages with the upper surface of the metal fitting storage hole 12b, and thereby the metal fitting 51 is secured to the housing 11.

When the metal fitting 51 is secured to the housing 11, the rear end part 52 is exposed to the rear of the housing 11. Furthermore, the second L-shaped part 56B is entirely stored in the side recessed part 13b, the arm part 56a is adjacent to or abuts the inner surface of the side wall part 16, and the tip end part 56b is adjacent to or abuts the inner surface of the side upper wall part 15b. On the other hand, at least a portion of the first L-shaped part 56A is exposed to the outside of the housing 11. Specifically, the arm part 56a penetrates the lower wall opening 14a in the vertical direction while being close to or in contact with the inner surface of side wall part 16. The tip end part 56b is located below lower wall part 14, and the opposing surface 56b1 is close to or in contact with the outer surface of the lower wall part 14, or in other words, the lower surface of the housing 11. Therefore, the opposing surface 56b1 of the first L-shaped part 56A and the opposing surface 56b1 of the second L-shaped part 56B face each other via the lower wall part 14, which is one of the walls of the housing 11.

In this manner, in the connector 10, the storage recessed part 13 of the housing 11 has a roughly C-shape or U-shape when viewed from the mating direction, with both end portions protruding upward, and therefore has a so-called polarity, and can only be mated when the mating convex part 114 of the counterpart connector 101 is in the correct position relative to the connector 10, and cannot be mated when the mating convex part 114 of the counterpart connector 101 is in a position other than the correct position. Therefore, incorrect mating is reliably prevented. Furthermore, in order to provide polarity, the storage recessed part 13 has a vertically elongated space such that the side recessed part 13b protrudes upward beyond the main body recessed part 13a, which tends to make the side recessed part 13b insufficient in strength. However, in the present embodiment, the metal fittings 51 are stored in the side recessed part 13b, so that the strength of the side recessed part 13b can be maintained sufficiently high, making the entire connector 10 robust. Furthermore, a lower wall opening 14a is formed in the lower wall part 14 in the side recessed part 13b, but the arm part 56a of the first L-shaped part 56A penetrates the lower wall opening 14a in the vertical direction while being close to or in contact with the inner surface of the side wall part 16, and the opposing surface 56b1 of the tip end part 56b is close to or in contact with the outer surface of the lower wall part 14, so that the strength of the lower wall part 14 of the side recessed part 13b can be maintained sufficiently high. Furthermore, the mating side parts 114b formed on both end portions in the width direction of the mating main body part 114a of the mating convex part 114 of the counterpart connector 101 stored in the storage recessed part 13 are covered by both metal fittings 51, so deformation or damage to the connector 10 is reliably prevented even when subjected to a strong external force that is sufficiently strong enough to gouge the counterpart connector 101.

In the present embodiment, the connector 10 in which the terminals 61 and the metal fittings 51 are attached to the housing 11 is mounted on the surface 91a of the substrate 91 as a right angle type connector, as depicted in FIGS. 7A and 7B. Specifically, the lower surface 62a of the tail part 62 of each terminal 61 is electrically and mechanically connected to each of the connecting pads 92 formed on the surface 91a of the substrate 91 by connection means such as soldering or the like. It should be noted that each of the connecting pads 92 is connected to a conductive trace (not depicted) provided on the substrate 91 and functions as a signal line, a power line, or a ground line. In addition, the lower surface (the surface opposite the opposing surface 56b1) of the tip end part 56b of the first L-shaped part 56A of each metal fitting 51 is electrically and mechanically connected to each of the connecting pads 92 formed on the surface 91a of the substrate 91 by connecting means such as soldering or the like. It should be noted that each of the connecting pads 92 is not connected to a conductive trace (not depicted) provided on the substrate 91.

Next, the configuration of the counterpart connector 101 will be described.

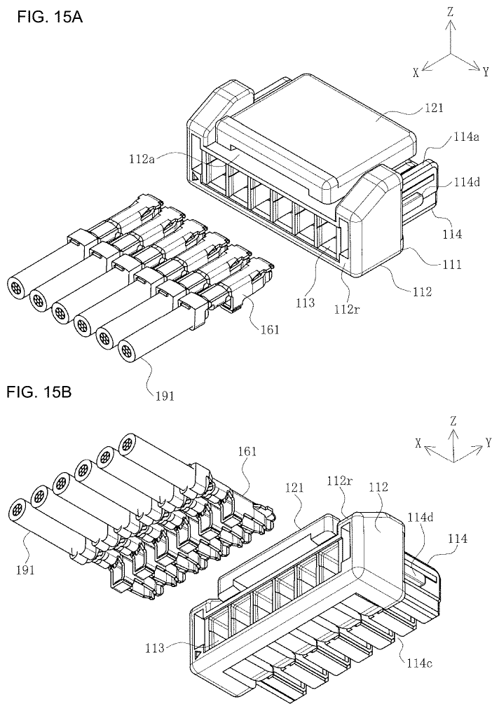

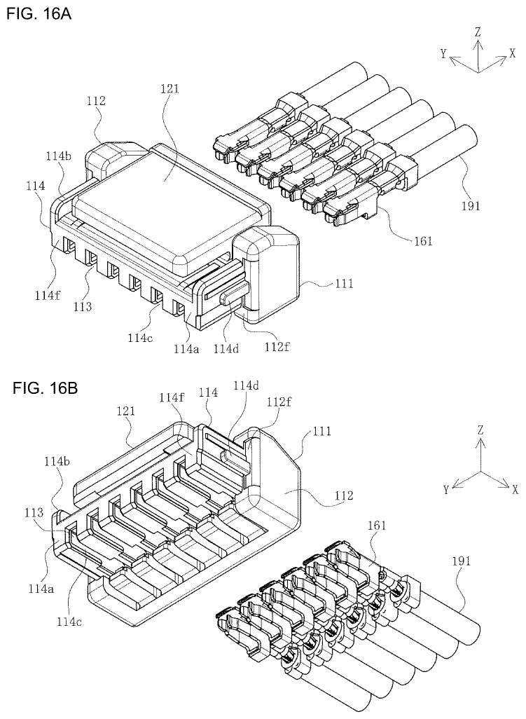

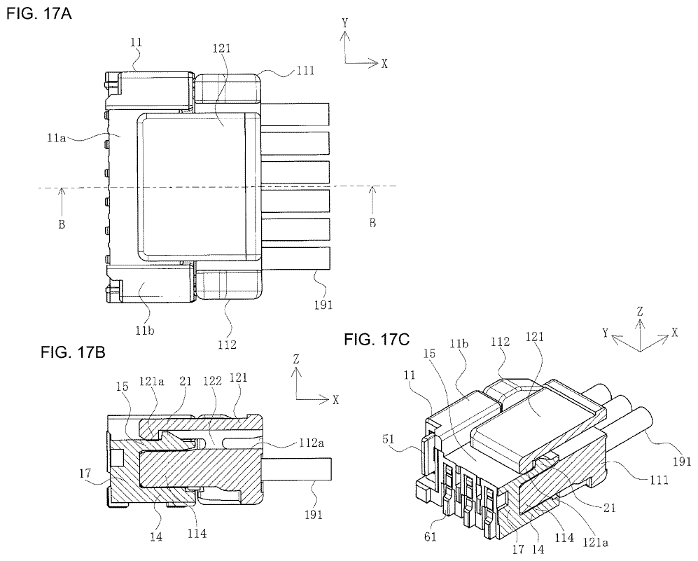

FIGS. 15A and 15B depict a first and second exploded perspective view of the counterpart connector of the first embodiment; FIGS. 16A and 16B depict a third and fourth exploded perspective view of the counterpart connector of the first embodiment; and FIGS. 17A-17C depict a three view diagram depicting the state after mating of the connector and the counterpart connector of the first embodiment. It should be noted that in FIGS. 15A and 15B, FIG. 15A is a first perspective view, and FIG. 15B is a second perspective view; in FIGS. 16A and B, FIG. 16A is a third perspective view, and FIG. 16B is a fourth perspective view; and in FIGS. 17A-17C, FIG. 17A is a top view, FIG. 17B is a cross-sectional view taken along line B-B in FIG. 17A, and FIG. 17C is a perspective view including a cross-section taken along line B-B in FIG. 17A.

The counterpart connector 101 in the present embodiment has a counterpart housing 111 which is integrally formed from an insulating material such as synthetic resin or the like, and has an overall shape roughly resembling a flattened rectangular prism, and a metal counterpart terminal 161 attached to the counterpart housing 111. The number and arrangement of counterpart terminals 161 can be set arbitrarily, but for the convenience of description, the number and arrangement are assumed to be the same as the terminals 61 of the connector 10. In other words, the number of counterpart terminals 161 and electric wires 191 connected to the counterpart terminals 161 is six, which are arranged in a row in the width direction (Y-axis direction) of the counterpart connector 101.

The counterpart housing 111 includes a roughly rectangular box-shaped housing main body 112 extending in a direction perpendicular to the mating direction with the connector 10 and in the arrangement direction of the electric wires 191, or in other words, in the width direction (Y-axis direction) of the counterpart connector 101, a mating convex part 114 protruding forward (negative X-axis direction) from a front surface 112f of the housing main body 112, and a counterpart locking member 121 connected to an upper surface 112a of the housing main body 112. The mating convex part 114 includes a mating main body 114a extending elongated in the width direction (Y-axis direction) and mating side parts 114b formed at both end portions of the mating main body 114a in the width direction and protruding upward, and has an approximately C-shape or U-shape when viewed from the mating direction. It should be noted that a side surface convex part 114d is provided on the outer surface of the mating side part 114b.

Furthermore, the counterpart housing 111 includes a plurality of terminal storage recessed parts 113 that have one end open on a rear surface 112r of the housing main body 112 and penetrate the interior of the counterpart connector 101 in the front-back direction (X-axis direction). A counterpart terminal 161 connected to and secured to the front end of each electric wire 191 is stored and held in each terminal storage recessed part 113. The other end of the terminal storage recessed part 113 opens to a front surface 114f of the mating convex part 114. Furthermore, slit-shaped openings 114c extending in the front-back direction are formed on the lower surface of the mating convex part 114 at locations corresponding to the terminal storage recessed parts 113. Therefore, each terminal storage recessed part 113 communicates with the lower outside of the mating convex part 114 through the opening 114c.

The counterpart terminals 161 connected to the ends of the electric wires 191 are inserted into and attached to the corresponding terminal storage recessed parts 113 from the rear surface 112r side of the housing main body 112 of the counterpart housing 111. As depicted in FIGS. 1 to 4, when attachment of the counterpart terminal 161 is complete, the entire counterpart terminal 161 is stored in the terminal storage recessed part 113. In addition, the tip end of the counterpart terminal 161 reaches near the tip end of the mating convex part 114, or in other words, near the front surface 114f, and the boundary between the rear end of the counterpart terminal 161 and the electric wire 191 is located in the terminal storage recessed part 113.

The counterpart locking member 121 is a swingable movable arm member, and as depicted in FIGS. 17A-17C, is integrally connected to an upper surface 112a of the housing main body 112 via a connecting part 122. The connecting part 122 is an elastically deformable member connected between the front end and rear end of the counterpart locking member 121, thereby allowing the counterpart locking member 121 to swing relative to the counterpart housing 111 around the point of connection to the connecting part 122. In addition, a locking protrusion 121a protruding toward the upper surface 112a of the housing main body 112 is formed at the front end (end in the negative direction of the X-axis) of the counterpart locking member 121, and the locking protrusion 121a engages with the convex locking member 21 of the connector 10, thereby locking the connector 10 and the counterpart connector 101 in the mutually engaged state.

It should be noted that the locking mechanism including the locking member 21 of the connector 10 and the counterpart locking member 121 of the counterpart connector 101 is a so-called positive lock, and when locking, the operator does not need to operate either the locking member 21 or the counterpart locking member 121. However, when releasing the lock, the operator needs to operate the counterpart locking member 121, which is a movable arm member, using a finger or the like to displace the locking protrusion 121a. Specifically, when the operator presses down on the rear end (end in the positive direction of the X-axis) of the counterpart locking member 121, the counterpart locking member 121 swings and the locking protrusion 121a formed on the front end thereof rises, thereby releasing the engagement between the locking member 21 and the counterpart locking member 121 and thus releasing the lock.

Next, the operation of mating the counterpart connector 101, which is an electric wire connector, to the connector 10, which is a substrate connector, will be described.

Here, the counterpart connector 101 is connected to the end of a cable having a plurality of electric wires 191 when the counterpart terminal 161 where the first terminal 61 is connected to the end of the electric wire 191 is stored in the terminal storage recessed part 113. Furthermore, it is assumed that the connector 10 is mounted on the surface 91a of the substrate 91 as a right angle type connector, as depicted in FIGS. 7A and 7B.

First, the operator brings the mating convex part 114 of the counterpart connector 101 and the storage recessed part 13 of the connector 10 so as to face each other, as depicted in FIGS. 1 to 4. Next, the operator moves the connector 10 and/or the counterpart connector 101 closer to the mating side, and inserts the mating convex part 114 of the counterpart connector 101 into the storage recessed part 13 of the connector 10, thereby mating the connector 10 and the counterpart connector 101, as depicted in FIGS. 5A, 5B, 6A and 6B.

At this time, the mating main body 114a, which extends in the width direction (Y-axis direction) of the mating convex part 114, enters and is stored in the main body recessed part 13a, which extends in the width direction (Y-axis direction) of the storage recessed part 13, and the mating side parts 114b, which protrude upward at both ends in the width direction of the mating convex part 114 enter and are stored in the vertically elongated side recessed parts 13b that protrude upward from the main body recessed part 13a at both ends in the width direction (Y-axis direction) of the storage recessed part 13. Furthermore, the mating side part 114b includes the first L-shaped part 56A and the second L-shaped part 56B in the side recessed part 13b, and is covered by the metal fitting 51 having a generally C-shape or U-shape.

Furthermore, the contact parts 63 of the terminals 61 of the connector 10 enter into the respective terminal storage recessed parts 113 with one end that opens on the front surface 114f of the mating convex part 114, and come into contact with the counterpart terminals 161 in the respective terminal storage recessed parts 113. This brings the terminal 61 and the counterpart terminal 161 into a conductive state, and as a result, the conductive trace connected to the connecting pad 92 formed on the surface 91a of the substrate 91 to which the tail part 62 of the terminal 61 is connected is conductive to the electric wire 191 to which the counterpart terminal 161 is connected.

Furthermore, as depicted in FIGS. 17A-17C, the locking protrusion 121a of the counterpart locking member 121 of the counterpart connector 101 engages with the convex locking member 21 of the connector 10. As a result, the connector 10 and the counterpart connector 101 are locked in a mutually mated state. In this case, the engagement state between the locking protrusion 121a and the locking member 21 can be visually observed from the outside of the counterpart locking member 121, so the operator can visually confirm whether or not locking has been completed. Therefore, the operator will not mistakenly believe that the lock has been completed. Thus, in the present embodiment, the connector 10 includes a housing 11 including a storage recessed part 13 for storing the counterpart connector 101, a terminal 61 attached to the housing 11, and a metal fitting 51 attached to the housing 11 for securing the housing 11 to the substrate 91. Furthermore, the metal fitting 51 includes a main body part 55 secured to the housing 11, a first L-shaped part 56A, at least a portion of which is exposed outside the housing 11 near the opening frontage 13f of the storage recessed part 13, and a second L-shaped part 56B exposed in the opening frontage 13f of the storage recessed part 13. The first L-shaped part 56A and the second L-shaped part 56B include opposing surfaces 56b1 that face each other via the lower wall part 14 of the housing 11. The main body part 55 is flat, the second edge part 55b, which is the edge part of the main body part 55 on the second L-shaped part 56B side, includes an engaging convex part 55b1 that engages with the housing 11, and the first edge part 55a, which is the edge part of the main body part 55 on the first L-shaped part 56A side, includes a guide part 55al that can slide against the housing 11.

Thereby, disengagement between the housing 11 and the metal fitting 51 can be prevented, deformation or damage to the housing 11 and the metal fitting 51 can be reliably prevented, the metal fitting 51 can be reliably secured to the housing 11, the height and size can be reduced, the configuration can be simple, the number of parts can be reduced, and the configuration is robust, easy to manufacture, has low cost, and has enhanced reliability, even if the housing 11 and the metal fittings 51 are compact.

Furthermore, the main body part 55 also includes a rear edge part 52a that is visible from the metal fitting storage hole 12b, which is a through hole in the rear wall part 17 that serves as the bottom of the storage recessed part 13. Furthermore, the rear edge part 52a protrudes from the rear wall part 17. Furthermore, the housing 11 has a lower wall opening 14a on the side of the first L-shaped part 56A of the metal fitting 51 at the opening frontage 13f, and the arm part 56a connecting the first L-shaped part 56A to the main body part 55 is located in the lower wall opening 14a. Furthermore, front edge part 55c of the main body part 55 on the side facing the counterpart connector 101 has a metal fracture surface 55cl on the first L-shaped part 56A side, and the fracture surface 55cl is formed on the arm part 56a. Furthermore, one metal fitting 51 is attached to each side of the housing 11, and the housing 11 has a convex locking member 21 that engages with the counterpart connector 101, and the locking member 21 is located between the second L-shaped parts 56B of the metal fittings 51 on both sides.

Next, the second embodiment will be described. It should be noted that a description is omitted for parts having the same structure as those of the first embodiment by assigning the same reference numbers. Moreover, descriptions of the same operations and effects as those of the first embodiment will be omitted.

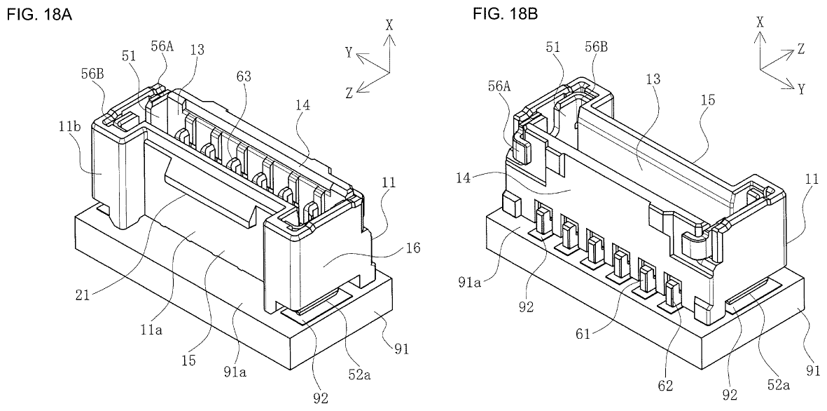

FIGS. 18A and 18B are a perspective view depicting a state in which the connector of the second embodiment is mounted on the surface of the substrate as a straight type connector. It should be noted that in FIGS. 18A and 18B, FIG. 18A is a first perspective view and FIG. 18B is a second perspective view.

In the present embodiment, the connector 10 where the terminals 61 and the metal fittings 51 are attached to the housing 11 is mounted on the surface 91a of the substrate 91 as a straight type connector, as depicted in FIGS. 18A and 18B. Specifically, the rear surface 62b of the tail part 62 of each terminal 61 is electrically and mechanically connected to each of the connecting pads 92 formed on the surface 91a of the substrate 91 by connection means such as soldering or the like. It should be noted that each of the connecting pads 92 is connected to a conductive trace (not depicted) provided on the substrate 91 and functions as a signal line, a power line, or a ground line.

Furthermore, the rear edge part 52a of the rear end part 52 of each metal fitting 51 is electrically and mechanically connected to each of the connecting pads 92 formed on the surface 91a of the substrate 91 by connection means such as soldering. It should be noted that each of the connecting pads 92 is not connected to a conductive trace (not depicted) provided on the substrate 91.

It should be noted that the configuration of the connector 10 and the counterpart connector 101 of the present embodiment is the same as that of the first embodiment described above, and therefore, a description thereof is omitted.

Furthermore, an operation of mating the connector 10 and the counterpart connector 101 in the present embodiment and the configuration and effect of the state where the connector 10 and the counterpart connector 101 are mated are the same as those of the first embodiment, and therefore descriptions thereof are omitted.

Next, the third embodiment will be described. It should be noted that a description is omitted for parts having the same structure as those of the first and second embodiments by assigning the same reference numbers. Moreover, descriptions of the same operations and effects as those of the first and second embodiments will be omitted.

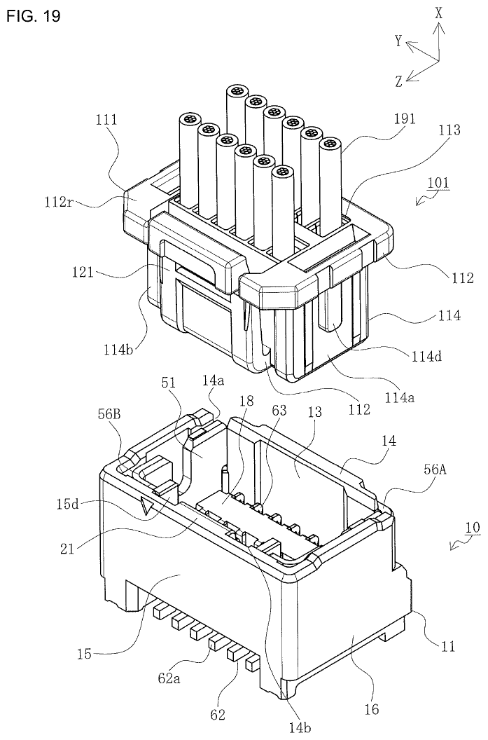

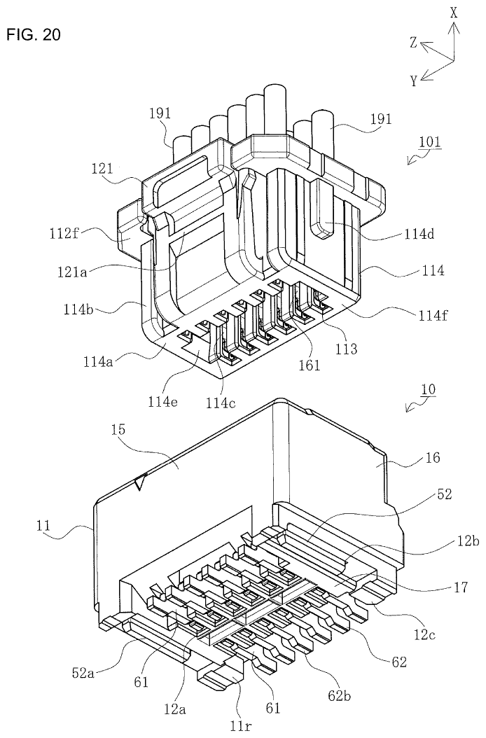

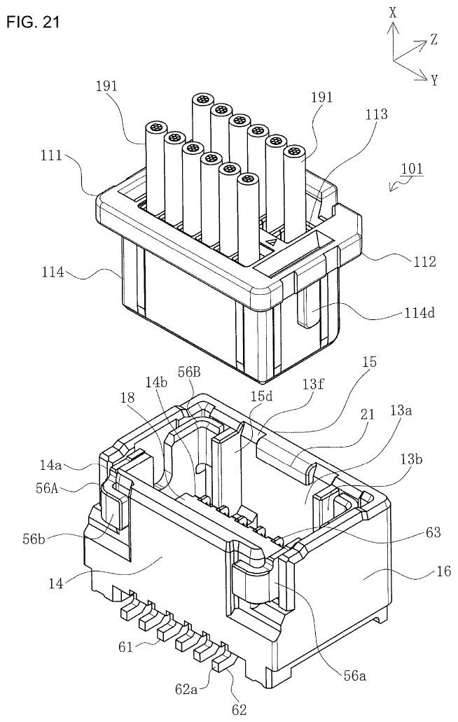

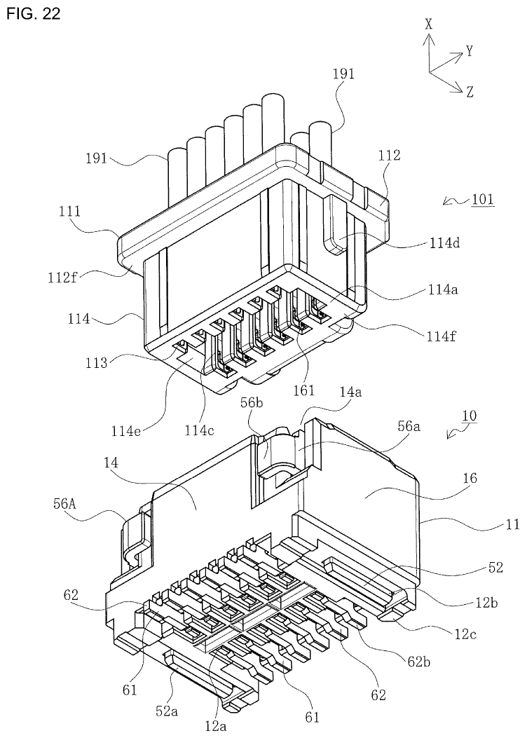

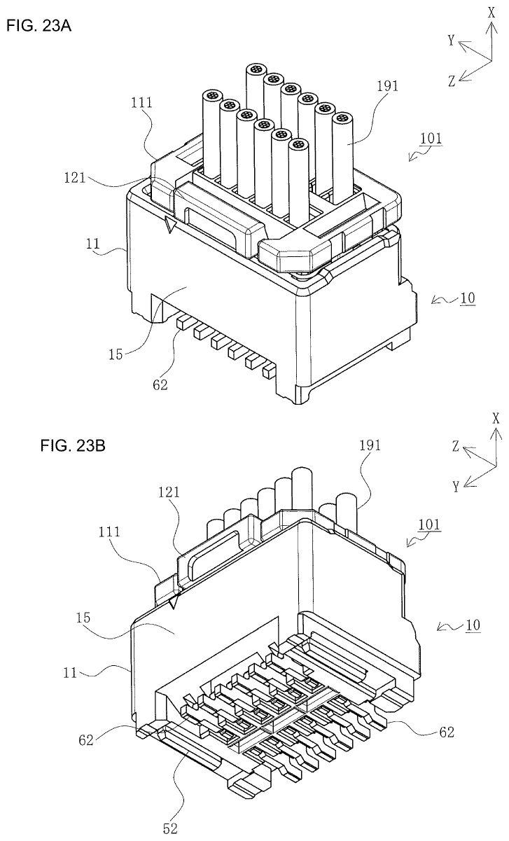

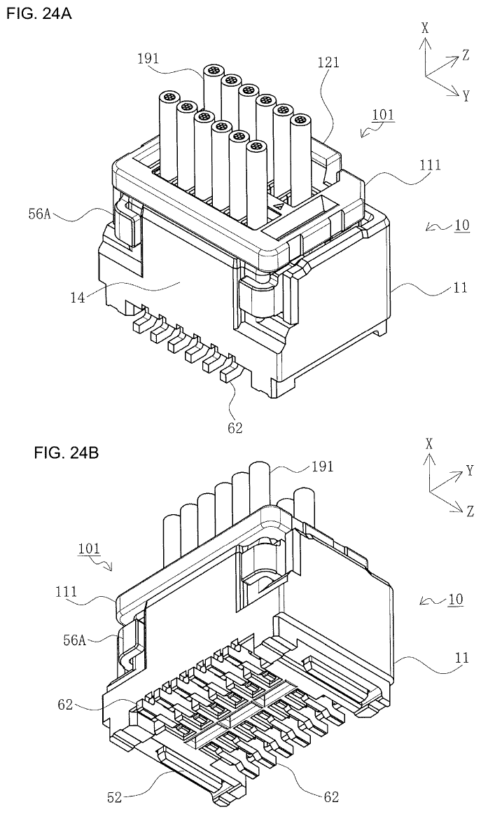

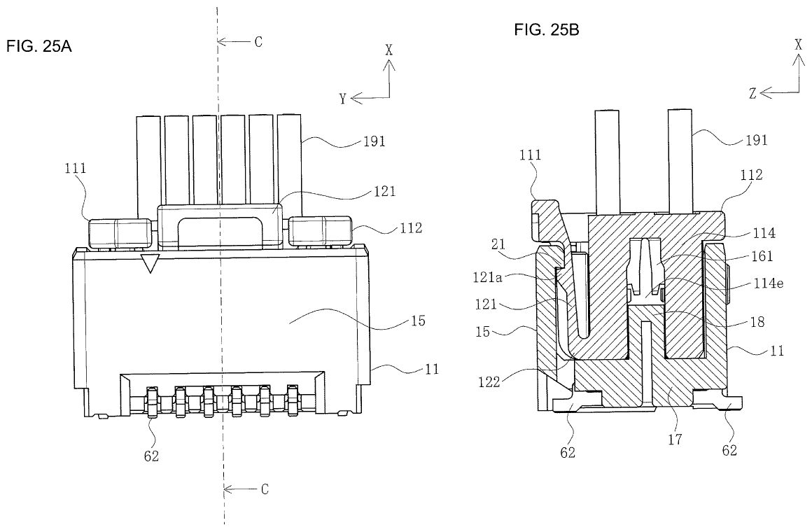

FIG. 19 is a first perspective view depicting the state prior to mating of the connector and the counterpart connector of the third embodiment; FIG. 20 is a second perspective view depicting the state prior to mating of the connector and the counterpart connector of the third embodiment; FIG. 21 is a third perspective view depicting the state prior to mating of the connector and the counterpart connector of the third embodiment; FIG. 22 is a fourth perspective view depicting the state prior to mating of the connector and the counterpart connector of the third embodiment; FIGS. 23A and 23B depict first and second perspective views depicting the state after mating of the connector and the counterpart connector of the third embodiment; FIGS. 24A and 24B depict third and fourth perspective views depicting the state after mating of the connector and the counterpart connector of the third embodiment; and FIGS. 25A and B are a two view diagram depicting the state after mating the connector and the counterpart connector of the third embodiment. It should be noted that in FIGS. 23A and 23B, FIG. 23A is a first perspective view, and FIG. 23B is a second perspective view; in FIGS. 24A and 24B, FIG. 24A is a third perspective view, and FIG. 24B is a fourth perspective view; and in FIGS. 25A and 25B, FIG. 25A is a plan view, and FIG. 25B is a cross-sectional view along arrow C-C in FIG. 25A.

In the present embodiment, the connector 10, which is a plug connector, is a substrate connector that is one of a wire-to-substrate connector pair, similar to the first embodiment, and is a connector that has a plurality of terminals 61. However, whereas in the connector 10 of the first embodiment, the plurality of terminals 61 are arranged in a row in the width direction (Y-axis direction) of the connector 10, in the present embodiment, the plurality of terminals 61 are arranged in a plurality of rows (two rows in the example depicted in the figure) in the width direction of the connector 10. It should be noted that the number of terminals 61 is also six for each row.

Furthermore, similar to the first embodiment, the counterpart connector 101, which is a receptacle connector, is an electric wire connector that is the other of the wire-to-substrate connector that is a connector pair, and is a connector that is connected to the end of a cable having a plurality of electric wires 191. However, in the counterpart connector 101 of the first embodiment, the plurality of counterpart terminals 161 and the electric wires 191 connected to the counterpart terminals 161 are arranged in a row in the width direction (Y-axis direction) of the counterpart connector 101, whereas in the present embodiment, the plurality of counterpart terminals 161 and the electric wires 191 connected to the counterpart terminals 161 are arranged in a plurality of rows (two rows in the example depicted in the figure) in the width direction of the counterpart connector 101. It should be noted that the number of counterpart terminals 161 and the electric wires 191 connected to the counterpart terminals 161 is also six for each row.

Furthermore, connector 10, which is a substrate connector, may be a so-called right-angle type connector or a straight type connector, but while in the first embodiment, the connector 10 is described as being a right angle type connector, and in the present embodiment, the connector 10 is described as being a straight type connector for the convenience of description.

In the present embodiment, the housing 11 of the connector 10 is a hollow box-shaped member having a generally flat overall shape, and includes a flat lower wall part 14 extending in the width direction (Y-axis direction) of the connector 10, an upper wall part 15 that is generally parallel to the lower wall part 14, and a pair of side wall parts 16 that extend in the vertical direction and connect the lower wall part 14 and the upper wall part 15. The interior thereof forms a storage recessed part 13 with a periphery defined by the lower wall part 14, the upper wall part 15, and the side wall part 16. The storage recessed part 13 is open on the front surface side (X-axis positive direction side) and is generally closed on the rear side (X-axis negative direction side) by a rear wall part 17 of the housing 11 which serves as the bottom part of the storage recessed part 13.

Furthermore, the lower wall part 14 and the upper wall part 15 each form a single flat plate that extends over the entire housing 11. It should be noted that the convex locking member 21 is formed on the inside of the upper wall part 15 which is the opening frontage 13f. Furthermore, plate-shaped section plates 15d that protrude toward the lower wall part 14 and extend in the front-back direction (X axis direction) are formed at locations on the inner side of the upper wall part 15 near both ends in the width direction (Y axis direction). The section plate 15d partitions the storage recessed part 13 into a main body recessed part 13a and a side recessed part 13b.

Furthermore, the rear surface 11r of the housing 11 is provided with terminal storage holes 12a into which the respective terminals 61 are inserted and stored. Each terminal storage hole 12a is formed as a through hole penetrating the rear wall part 17 in the plate thickness direction, and stores and holds the main body part 65 of each terminal 61. In the example depicted in the figure, a total of twelve terminal storage holes 12a are arranged in two rows in the width direction (Y-axis direction) of the connector 10.

Furthermore, a plate-like partition wall part 18 that extends (in the positive direction of the X-axis) toward the opening frontage 13f and in the width direction (in the Y-axis direction) is formed on the inner surface of the rear wall part 17. The partition wall part 18 divides the storage recessed part 13 into two parts in the vertical direction (Z-axis direction), and the upper portions and lower portions correspond to the respective row of the terminal storage holes 12a. Furthermore, the contact parts 63 of the terminals 61 are stored in a row in each of the upper portion and lower portion of the storage recessed part 13. It should be noted that ridge-like parts 14b that protrude upward and downward are formed on the upper surface and lower surface of the partition wall part 18, and each contact part 63 is located directly above and below each ridge-like part 14b in the upper portion and lower portion of the storage recessed part 13.

In the present embodiment, the counterpart housing 111 of the counterpart connector 101 includes a housing main body 112, a mating convex part 114 protruding forward (negative direction of the X-axis) from the front surface 112f of the housing main body 112, and a counterpart locking member 121 connected to the mating main body 114a of the mating convex part 114. The counterpart locking member 121 is a swingable movable arm member, and as depicted in FIGS. 25A and 25B, is integrally connected to the upper surface of the mating convex part 114 via a connecting part 122. The connecting part 122 is an elastically deformable member connected to the front end (end in the negative direction of the X-axis) of the counterpart locking member 121, thereby allowing the counterpart locking member 121 to swing relative to the counterpart housing 111 around the front end. In addition, a locking protrusion 121a that protrudes upward (positive direction of the Z-axis) is formed at a location toward the rear end of the counterpart locking member 121, and the locking protrusion 121a engages with the convex locking member 21 of the connector 10, and therefore the connector 10 and the counterpart connector 101 are locked in the mated state. It should be noted that in the present embodiment, the locking member 21 protrudes toward the inside of the storage recessed part 13 of the housing 11, and when the connector 10 and the counterpart connector 101 are mated together, the counterpart locking member 121 is stored in the storage recessed part 13 together with the mating main body 114a, and the locking protrusion 121a engages with the locking member 21.

Furthermore, the terminal storage recessed parts 113 into which the counterpart terminals 161 connected to the ends of the electric wires 191 are inserted and stored are open on the rear surface 112r of the housing main body 112. Each terminal storage recessed part 113 is formed so as to penetrate the interior of the counterpart connector 101 in the front-back direction (X-axis direction), and stores and holds each counterpart terminal 161. In the example depicted in the figure, a total of twelve terminal storage recessed parts 113 are arranged in two rows in the width direction (Y-axis direction) of the counterpart connector 101.

Furthermore, a mating recessed part 114e opening to a front surface 114f is formed in the mating main body 114a of the mating convex part 114, and the terminal storage recessed parts 113 are stored in a row in the wall of the mating main body 114a above the mating recessed part 114e and in the wall of the mating main body 114a below the mating recessed part 114e. Furthermore, slit-shaped openings 114c extending in the front-back direction are formed in the wall of the mating main body 114a at locations corresponding to the terminal storage recessed parts 113. Therefore, each terminal storage recessed part 113 communicates with the inside of the mating recessed part 114e through the opening 114c. Furthermore, when the connector 10 and the counterpart connector 101 are mated together, the partition wall part 18 of the housing 11 is stored in the mating recessed part 114e.

It should be noted that the configuration of the connector 10 and the counterpart connector 101 of the present embodiment is the same as that of the first and second embodiments described above, and therefore a description thereof is omitted.

Furthermore, an operation of mating the connector 10 and the counterpart connector 101 in the present embodiment and the configuration and effect of the state where the connector 10 and the counterpart connector 101 are mated are the same as those of the first and second embodiments, and therefore descriptions thereof are omitted.

Next, the fourth embodiment will be described. It should be noted that a description is omitted for parts having the same structure as those of the first to third embodiment by assigning the same reference numbers. Moreover, descriptions of the same operations and effects as those of Embodiments 1 to 3 will be omitted.

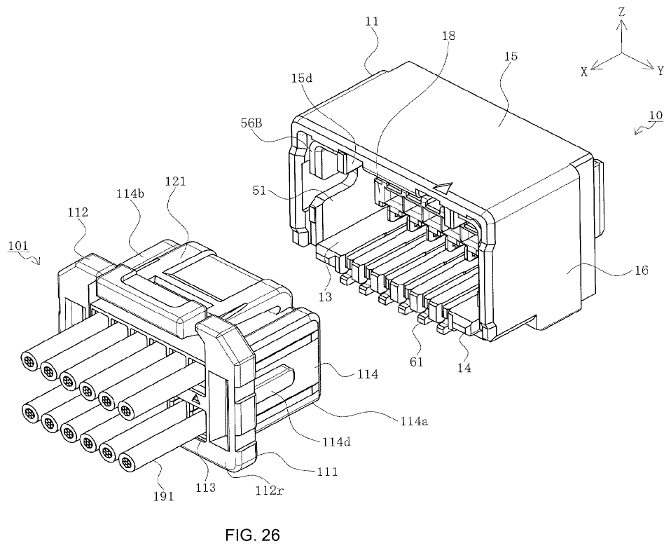

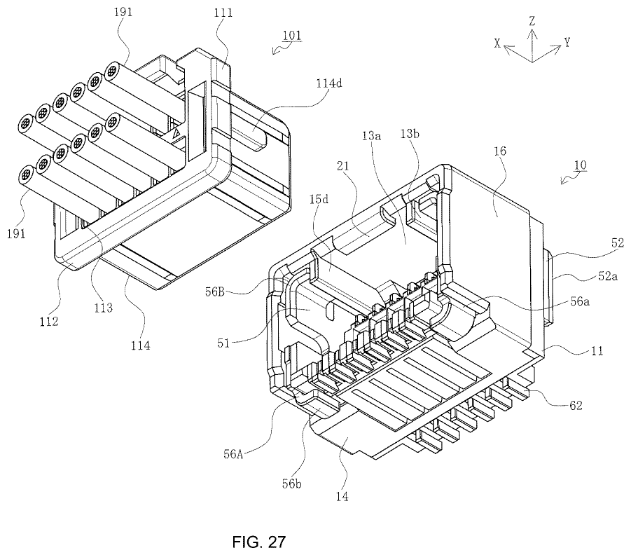

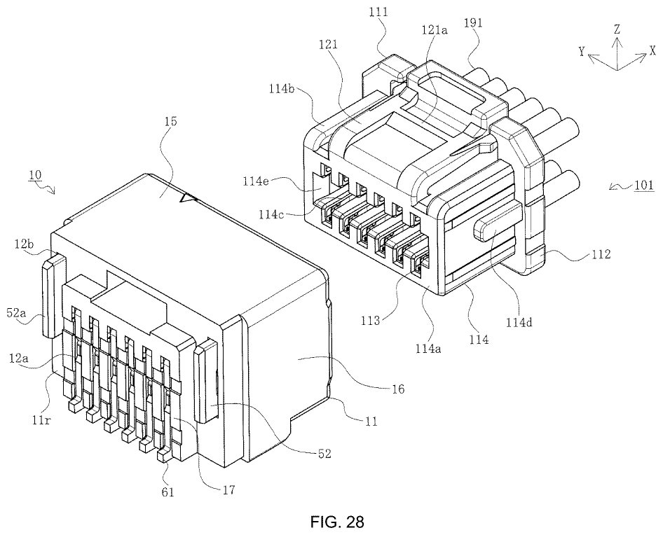

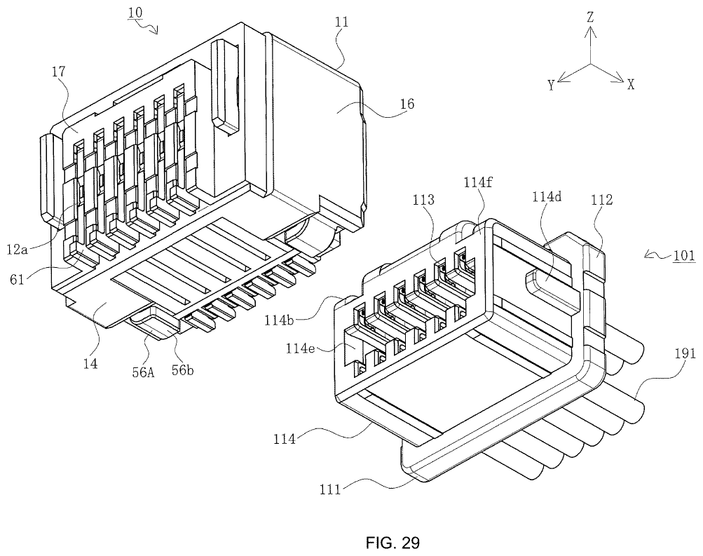

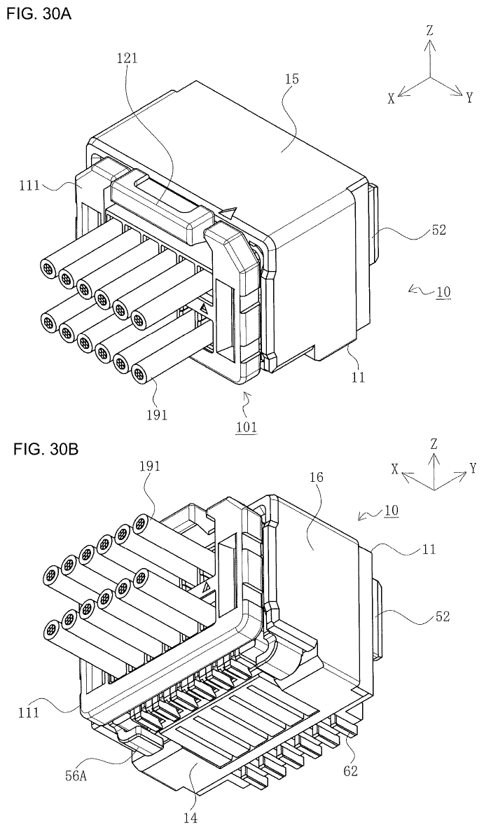

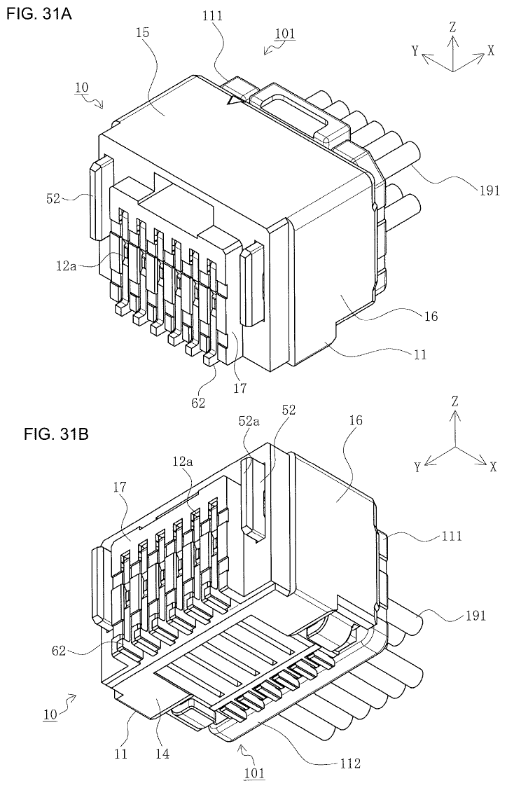

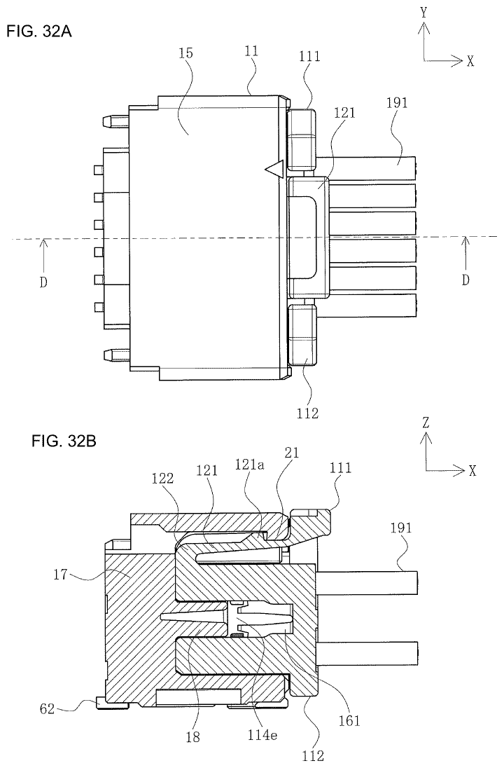

FIG. 26 is a first perspective view depicting the state prior to mating of the connector and the counterpart connector of the fourth embodiment; FIG. 27 is a second perspective view depicting the state prior to mating of the connector and the counterpart connector of the fourth embodiment; FIG. 28 is a third perspective view depicting the state prior to mating of the connector and the counterpart connector of the fourth embodiment; FIG. 29 is a fourth perspective view depicting the state prior to mating of the connector and the counterpart connector of the fourth embodiment; FIGS. 30A and 30B depict first and second perspective views depicting the state after mating of the connector and the counterpart connector of the fourth embodiment; FIGS. 31A and 31B depict third and fourth perspective views depicting the state after mating of the connector and the counterpart connector of the fourth embodiment; and FIGS. 32A and 32B are a two view diagram depicting the state after mating of the connector and the counterpart connector of the fourth embodiment. It should be noted that in FIGS. 30A and 30B, FIG. 30A is a first perspective view, and FIG. 30B is a second perspective view; in FIGS. 31A and 31B, FIG. 31A is a third perspective view, and FIG. 31B is a fourth perspective view; and in FIGS. 32A and 32B, FIG. 32A is a plan view, and FIG. 32B is a cross-sectional view along arrow D-D in FIG. 32A.

In the present embodiment, connector 10, which is a substrate connector, may be a so-called right angle type connector or a straight type connector, but while in the third embodiment, the connector 10 is described as being a straight type connector, in the present embodiment, the connector 10 is described as being a right-angle type connector for the sake of description.

Furthermore, as in the third embodiment, the connector 10, which is a plug connector, has a plurality of terminals 61 arranged in a plurality of rows (two rows in the example depicted in the figure) in the width direction of the connector 10. It should be noted that the number of terminals 61 is also six for each row.

Furthermore, in the counterpart connector 101, which is a receptacle connector, similar to the third embodiment, a plurality of counterpart terminals 161 and electric wires 191 connected to the counterpart terminals 161 are arranged in a plurality of rows (two rows in the example depicted in the figure) in the width direction of the connector 101. It should be noted that the number of counterpart terminals 161 and the electric wires 191 connected to the counterpart terminals 161 is also six for each row.

It should be noted that the configuration of the connector 10 and the counterpart connector 101 of the present embodiment is the same as that of the first to third embodiments described above, and therefore a description thereof is omitted.

Furthermore, an operation of mating the connector 10 and the counterpart connector 101 in the present embodiment and the configuration and effect of the state where the connector 10 and the counterpart connector 101 are mated are the same as those of the first to third embodiments, and therefore descriptions thereof are omitted.

It should be noted that the disclosure herein describes features relating to suitable exemplary embodiments. Various other embodiments, modifications, and variations within the scope and spirit of the claims appended hereto will naturally be conceived of by a person of ordinary skill in the art upon review of the disclosure herein.

The present disclosure can be applied to a connector and a connector pair.

1. A connector, comprising: a housing including a storage recessed part for storing a counterpart connector, a terminal attached to the housing, and a metal fitting attached to the housing for securing the housing to a substrate; wherein
the metal fitting includes a main body part secured to the housing, a first L-shaped part at least a portion of which is exposed to the outside of the housing near the opening frontage of the storage recessed part, and a second L-shaped part exposed in the opening frontage of the storage recessed part;
the first L-shaped part and the second L-shaped part include surfaces that face each other across a wall of the housing; and
the main body part is flat, the edge part of the main body part on the second L-shaped part side includes a convex part that engages with the housing, and the edge part of the main body part on the first L-shaped part side includes a guide part that can slide against the housing.

2. The connector according to claim 1, wherein the main body part includes a first edge part visible through a through hole in a bottom part of the storage recessed part.

3. The connector according to claim 2, wherein the first edge part protrudes from the bottom part.

4. The connector according to claim 1, wherein the housing has a slit on the first L-shaped part side of the metal fitting at the opening frontage, and an arm part connecting the first L-shaped part to a main body part is positioned in the slit.

5. The connector according to claim 4, wherein an edge part of the main body part facing the counterpart connector has a metal fracture surface on the first L-shaped part side, the fracture surface being formed on the arm part.

6. The connector according to claim 1, wherein one metal fitting is attached to each side of the housing, the housing having a convex locking member that engages with the counterpart connector, and the locking member is positioned between the second L-shaped parts of the metal fittings on both sides.

7. A connector pair, comprising: the connector according to claim 1, and a counterpart connector that mates with the connector.
